(19) United States
(12) Patent Application Publication
(10) Pub. No.: US 2010/0144453 A1
(43) Pub. Date: Jun. 10, 2010

(54) CONNECTION JOINT AND COMPOSITE DRIVE SHAFT ASSEMBLY HAVING THEM

(76) Inventor: Choong O Ryu, Gimhae-si (KR)

Correspondence Address: CHRISTOPHER PAUL MITCHELL, 888 16TH ST., NW, SUITE 800, WASHINGTON, DC, 20006, US

(21) Appl. No.: 12/530,217

(22) PCT Filed: Apr. 7, 2008
(86) PCT No.: PCT/KR2008/001954

§ 371 Date: Sep. 7, 2009

(30) Foreign Application Priority Data
Apr. 10, 2007 (KR) 10-2007-0034899

(51) Int. Cl. F16D 1/06

(52) U.S. Cl. 464/182

(57) ABSTRACT

The present invention provides a connection joint, which is configured to be efficiently fastened to each end of a composite drive shaft having respective power transmission parts in opposite ends thereof. Further, the present invention also provides a composite drive shaft assembly, which has an integrated structure realized by easily fastening respective connection joints in opposite ends of the composite drive shaft, most of which, except for the opposite ends functioning as power transmission parts, has a tubular shape with a circular cross-section, similar to that of a general shaft, so that the composite drive shaft assembly can efficiently transmit high torque.

### TECHNICAL FIELD

The present invention relates, in general, to a connection joint provided in each end of a composite drive shaft and, more particularly, to a connection joint, which is configured to be fastened in each end of a composite drive shaft having respective power transmission parts in opposite ends thereof. Further, the present invention relates to a composite drive shaft assembly, which is integrated into a single body by easily fastening respective connection joints in opposite ends of a composite drive shaft, most of which, except for opposite ends functioning as power transmission parts of the drive shaft, has a tubular shape with a circular cross-section similar to that of a general shaft.

### BACKGROUND ART

A drive shaft is a device that transmits the rotating force of an engine or a gear box to driving axles, and is widely used in machinery including transport machines, such as automobiles, ships and aircraft.

A conventional drive shaft is made of metal and is typically produced by separately producing a tube part and a universal joint part of the shaft and press-fitting and welding them into a single shaft. In the related art, drive shafts made from steel or aluminum are widely used. However, the metal drive shaft is problematic in that it is heavy and has a low lateral directional resonance frequency. Thus, when the length of the metal drive shaft is not less than 2 meters, the drive shaft may resonate within a range of a maximum engine rpm and may break due to the low lateral directional resonance frequency thereof. Therefore, two metal drive shafts, each having a short length of about 1 meter, are separately produced and are connected to each other to form a jointed single drive shaft. However, to connect the two short metal drive shafts to each other, a universal joint must be used, resulting in an increase in the weight and operational noise of the drive shaft.

In an effort to solve the problems with the conventional metal drive shafts, a composite drive shaft, made of a fiber-reinforced composite material, has been proposed and used. The fiber-reinforce composite drive shaft has a higher specific rigidity, a higher specific strength, a higher resonance frequency and a higher vibration damping capability, compared to the conventional metal drive shafts, so that a fiber-reinforced composite drive shaft having a length equal to or longer than 2 meters can be produced and used. Further, when a drive shaft is produced using the fiber-reinforced composite material, the drive shaft eliminates the need for the universal joint, so that the drive shaft can be even lighter and generates less noise. Thus, in advanced countries, such fiber-reinforced composite drive shafts are preferably used in special applications, such as in racing cars or aircraft.

The conventional composite drive shaft is produced through the following process. First, a fiber-reinforced composite material is layered on the circumferential surface of a mandrel, which has a circular cross-section and is coated with a release agent on the surface, prior to winding a compression film made of a high polymer, such as polypropylene or polyethylene, on the surface. Thereafter, the mandrel having the composite material thereon is covered with a vacuum bag, made of a high temperature nylon film, and high temperature and high pressure are applied to the interior of the vacuum bag from external sources in the state in which the interior of the vacuum bag is maintained in a vacuum state using a vacuum pump, thus hardening the composite material. When the composite material on the mandrel has been completely hardened, the mandrel is removed from the hardened fiber-reinforced composite material, thus providing a composite drive shaft.

Another conventional method of producing composite drive shafts has been proposed and is disclosed in Korean Patent No. 241232. The method comprises: layering a fiber-reinforced composite material on the circumferential surface of a mandrel coated with a release agent; inserting a heat shrinkable tube, made of a heat shrinkable material selected from the group consisting of cross-linked polyolefin, polyethylene and polypropylene, into the fiber-reinforced composite material layered on the surface of the mandrel; heating the heat shrinkable tube in an oven, thus allowing the resin to be charged in the fiber-reinforced composite material and hardening the fiber-reinforced composite material; and removing the hardened fiber-reinforced composite material from the mandrel, thus providing a composite drive shaft.

Each of the composite drive shafts, produced through the above-mentioned conventional methods, has a tubular shape, which has a constant cross-section from a first end to a second end thereof. Thus, a variety of techniques for connecting respective connection joints (metal yokes) to the opposite ends of a conventional composite drive shaft have been actively studied and developed. The conventional techniques of connecting respective connection joints to the opposite ends of a composite drive shaft are classified into mechanical fastening jointing and adhesive bonding jointing.

To realize mechanical fastening jointing, a composite material is holed and, thereafter, a connection joint is mechanically fastened to the hole in an associated end of the composite material through pinning, bolting or riveting. However, such mechanical fastening jointing is problematic in that the holing process may damage the texture of the composite material of the drive shaft due to the breakage of fibers of the composite material caused by the holing. Further, because the composite material is an anisotropic material, the stress concentration factor in the mechanically fastened part of the composite material may be increased compared to that of an isotropic material. Another problem with the mechanical fastening jointing resides in that the stress concentrated portion in the composite material may be easily fatigued when a load is repeatedly applied thereto, and noise and vibration may be easily generated in the mechanically fastened part due to the asymmetry of the mechanically fastened part.

Compared to the mechanical fastening jointing, adhesive bonding jointing is advantageous in that it can distribute a load over a larger area and eliminates the need to form holes in the composite material, so that it avoids breaking fibers of the composite material. Thus, adhesive bonding jointing allows the adhesively bonded part to efficiently resist a load repeatedly applied thereto and to be less fatigued, and reduces noise and vibration, unlike the mechanical fastening jointing. However, the adhesive bonding jointing requires a process of treating the surface of the bonded product and is limited by temperature, humidity, etc. Further, the bonding strength of the bonded part may be easily changed according to the skill of a worker during a bonding process. Particularly, because a bonding agent used in the adhesive bonding jointing has a high brittleness index, it is almost impossible to adapt the adhesive bonding jointing to a structure, which may be repeatedly loaded or may receive a load or a torque higher than the bonding strength of a bonding agent used in the adhesive bonding jointing.

Thus, in an effort to overcome the problems of the conventional techniques of connecting the connection joints to a composite drive shaft, a variety of techniques have been proposed. For example, to connect respective connection joints (metal yokes) to the opposite ends of a composite drive shaft, Korean Patent No. 432991 proposed a thermal fitting technique, Korean Laid-open Publication No. 2004-0006568 proposed a thermal press-fitting technique, Korean Patent No. 515800 proposed a mechanical press-fitting technique, and Korean Patent No. 526020 proposed a press-fitting and thermal fitting technique using an insert ring. However, the above-mentioned conventional techniques, using the difference in the physical property between two materials, are problematic in that they require complicated processes, in which heating and/or cooling must be executed to realize the connection of the two materials and the application of an external force must be executed to realize mechanical engagement of the two materials.

The inventor of the present invention has discovered that the problems with the conventional techniques are caused by the fact that the shape of each of the conventional composite drive shafts is tubular, and has a constant cross-section from a first end to a second end. Thus, in an effort to overcome the problems with the conventional techniques, the inventor has developed a composite drive shaft having respective power transmission parts in opposite ends thereof, and has completed the present invention paying attention to a connection joint configured to be easily fastened in each end of the composite drive shaft.

### DISCLOSURE OF INVENTION

### Technical Problem

Accordingly, the present invention has been made keeping in mind the above problems occurring in the related art, and is intended to provide a connection joint, which is configured to be easily fastened in each end of a composite drive shaft having respective power transmission parts in opposite ends thereof.

The present invention is also intended to provide a composite drive shaft assembly, which has an integrated structure realized by easily fastening respective connection joints in opposite ends of a composite drive shaft, most of which, except for the opposite ends, functioning as power transmission parts of the drive shaft, has a tubular shape with a circular cross-section, similar to that of a general shaft, so that the composite drive shaft assembly can efficiently transmit high torque.

### Technical Solution

In an aspect, the present invention provides a connection joint, which is fastened to a pair of protrusions in each end of a composite drive shaft, thus forming a composite drive shaft assembly, the pair of protrusions of the composite drive shaft being configured such that, regardless of a position at which the drive shaft having the protrusions on an inner surface thereof is cut in a transverse direction, a transverse directional length thereof can be maintained constant, and each comprising a first protrusion longitudinally formed from each end of the drive shaft to a position spaced apart from the end by a predetermined distance, and a second protrusion inclinedly extending from the first protrusion to the inner surface of the drive shaft.

The connection joint comprises: a first joint unit, comprising a pair of locking members, the locking members having a symmetrical structure and each comprising: an outer surface configured such that, when the locking members are inserted into each end of the composite drive shaft in an assembled state, the outer surface is in close contact with the inner surface of the composite drive shaft having the pair of first protrusions; and an inner surface having an inclined surface, which is inclined downwards from a first end to a second end thereof; a second joint unit, comprising: an enlarged part being tapered in a direction from a first end to a second end thereof such that upper and lower surfaces thereof have respective inclined surfaces corresponding to the inner surfaces of the pair of locking members, thus being in surface contact with the inner surfaces of the locking members, with a pair of through holes formed in opposite sides of the enlarged part in longitudinal directions; and a connection part extending from the first end of the enlarged part; and a third joint unit comprising: a locking part configured to be inserted into each end of the composite drive shaft along the pair of first protrusions and to be fastened to the pair of second protrusions; and an assembling part extending from a surface of the locking part so as to be inserted into the through holes in the second joint unit prior to being fastened to an end of the second joint unit, thus fastening the pair of locking members of the first joint unit to the inner surface of the composite drive shaft.

The locking part of the third joint unit may comprise: a pair of first depressions having a shape corresponding to the pair of first protrusions formed in each end of the composite drive shaft, so that the first depressions can be inserted into each end of the drive shaft along the first protrusions; and a pair of second depressions formed at locations angularly spaced apart from the pair of first depressions at angles of 90° and having a shape corresponding to part of the pair of second protrusions, thus being fastened to the second protrusions.

In another aspect, the present invention provides a composite drive shaft assembly comprising: the composite drive shaft; and the connection joint fastened in each end of the composite drive shaft. Here, a bonding using a bonding agent may be added to a junction between the first joint unit and the composite drive shaft.

The connection joint according to the present invention is configured to be fastened to each end of a composite drive shaft 100, which has a circular cross-sectional tubular shape, as shown in FIG. 1, and has respective power transmission parts in opposite ends thereof. Here, the power transmission parts of the composite drive shaft 100 have respective outer depressions 110 and inner protrusions 120, which are configured such that, regardless of the position at which the drive shaft having the depressions and protrusions is cut in a transverse direction, the thickness and transverse directional length thereof are the same. Here, each of the outer depressions 110 is configured to be symmetrical with the round surface of the circular cross-sectional tubular drive shaft, and comprises a curved depression 111, which is longitudinally formed from one end of the drive shaft at a position spaced apart from the end by a predetermined distance, and an inclined depression 112, which longitudinally extends from the curved depression 111 to the round surface of the drive shaft such that the inclined depression forms a curved surface. Thus, each of the inner protrusions 120 comprises a curved protrusion 121 (first protrusion) and an inclined protrusion 122 (second protrusion) corresponding to each of the outer depressions 110.

### Advantageous Effects

The connection joint according to the present invention has a structure capable of being easily fastened in an assembled state to each end of a composite drive shaft having respective power transmission parts in opposite ends thereof.

Further, the composite drive shaft assembly according to the present invention has an integrated structure realized by easily fastening respective connection joints in opposite ends of a composite drive shaft, most of which, except for opposite ends functioning as power transmission parts of the drive shaft, has a tubular shape with a circular cross-section similar to that of a general shaft, so that the composite drive shaft assembly can efficiently transmit high torque. In other words, the composite drive shaft assembly of the present invention can directly transmit power instead of a conventional power transmission technique, such as mechanical fastening jointing and adhesive bonding jointing, so that the composite drive shaft assembly of the present invention can efficiently transmit high torque.

Further, the composite drive shaft assembly of the present invention eliminates the need to form holes in power transmitting ends thereof, thus preventing stress concentration which may occur at the holes.

Further, the composite drive shaft assembly of the present invention does not use a power transmission method using a bonding agent, thus eliminating the need for surface treatment, and uses no bonding agent, thus not being affected by variation in weather conditions, such as temperature or humidity.

Further, the composite drive shaft assembly of the present invention may be almost permanently used, until the body of the shaft is broken, because it does not break at a hole or a bonded surface.

### BRIEF DESCRIPTION OF THE DRAWINGS

FIG. 1 is a perspective view of a composite drive shaft, to which the present invention is adapted;

FIG. 2 is an exploded perspective view illustrating the construction and relationship of elements of a connection joint according to an embodiment of the present invention;

FIG. 3 and FIG. 4 are perspective views of the connection joint shown in FIG. 2 after the elements have been completely assembled into a single body;

FIG. 5 is a side view of a first joint unit shown in FIG. 2;

FIG. 6 is a perspective view of a second joint unit shown in FIG. 2;

FIG. 7 and FIG. 8 are a left side view and a front view of the second joint unit shown in FIG. 6;

FIG. 9 is a perspective view of a third joint unit shown in FIG. 2; and

FIG. 10 is a view illustrating the concept of a composite drive shaft assembly according to the present invention, which is formed by assembling the connection joint of FIG. 2 in each end of the composite drive shaft shown in FIG. 1.

### BEST MODE FOR CARRYING OUT THE INVENTION

Hereinbelow, preferred embodiments of a connection joint fastened in each power transmission part of a composite drive shaft and a composite drive shaft assembly having the connection joint according to the present invention will be described in detail with reference to the accompanying drawings.

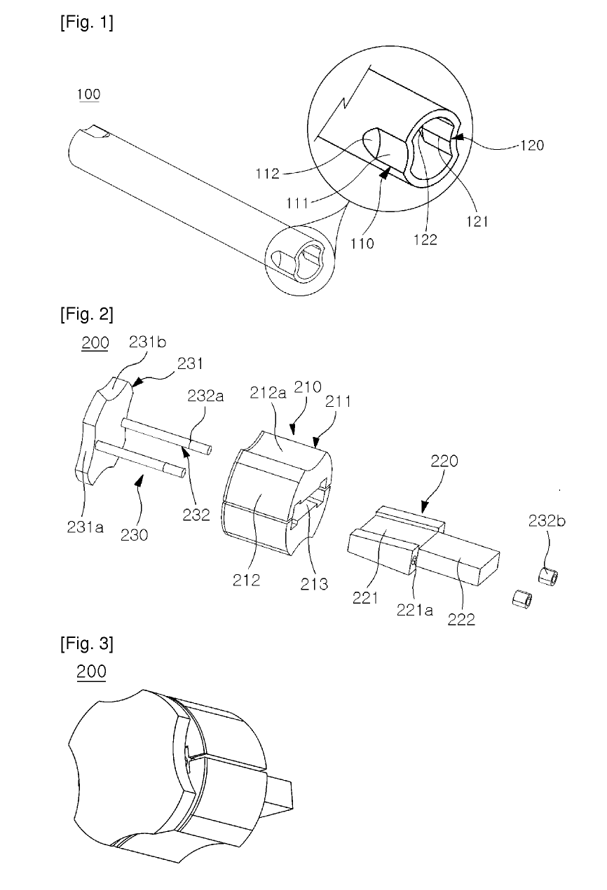

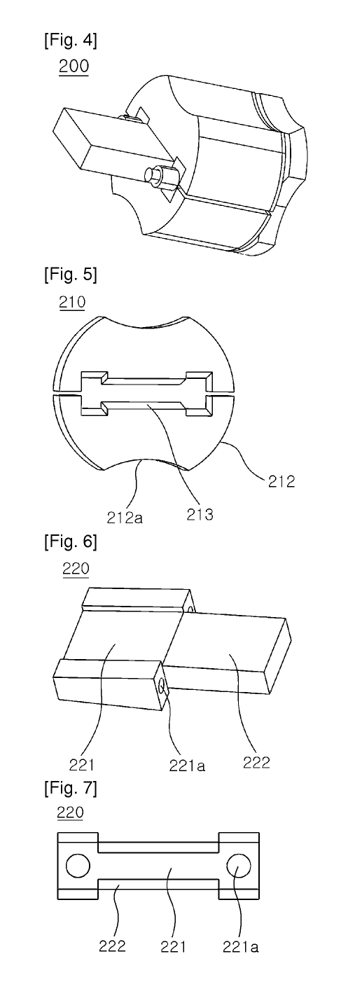

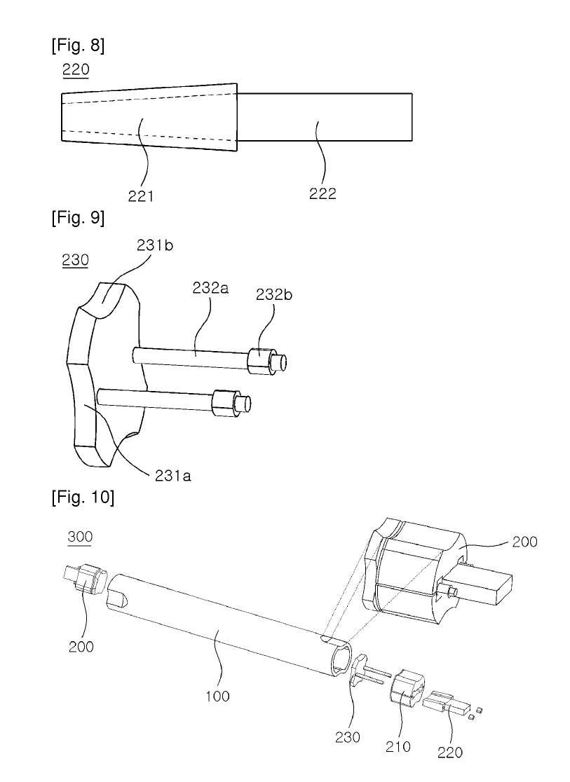

FIG. 2 is an exploded perspective view illustrating the construction of and relationship between elements of a connection joint according to an embodiment of the present invention. FIG. 3 and FIG. 4 are perspective views of the connection joint shown in FIG. 2 after the elements have been completely assembled into a single body. FIG. 5 is a side view of a first joint unit shown in FIG. 2. FIG. 6 is a perspective view of a second joint unit shown in FIG. 2. FIG. 7 and FIG. 8 are a left side view and a front view of the second joint unit shown in FIG. 6. FIG. 9 is a perspective view of a third joint unit shown in FIG. 2.

As shown in FIG. 2 through FIG. 9, the connection joint 200 according to the embodiment of the present invention comprises first, second and third joint units 210, 220 and 230.

The first joint unit 210 comprises a pair of locking members 211, which have a symmetrical structure and are assembled with each other into a shape capable of being inserted into each end of the composite drive shaft 100. Each of the two locking members 211 has a length corresponding to the length of a curved protrusion 121 of the composite drive shaft 100, and comprises an outer surface 212 and an angled inner surface 213. When the assembled locking members 211 are inserted into each end of the composite drive shaft 100, the outer surface 212 is in surface contact with the inner surface of the composite drive shaft 100 and the angled inner surface 213 is in surface contact with the outer surface of the second joint unit 220.

The outer surface 212 of each locking member 211 comprises a curved depression 212a, is shaped to correspond to the shape of the curved protrusion 121, formed in each end of the composite drive shaft 100, so as to be in surface contact with the curved protrusion 121. Each of the locking members 211 also has curved surfaces on opposite sides of the curved depression 212a so as to be in surface contact with the inner surface of the composite drive shaft 100.

Further, the angled inner surfaces 213 of the locking members 211 are configured to have angled corners so as to correspond to the shape of the outer surface of the second joint unit 220. The angled inner surface 213 of each locking member 211 is partially inclined downwards from one end to the other end, thus having an inclined surface. Here, the inclined inner surface of each locking member 211 is shaped to correspond to the outer surface of the second joint unit 220. Thus, the second joint unit 220 opens the two locking members 211, thus allowing the outer surfaces of the locking members 211 to come into close surface contact with the inner surface of each end of the composite drive shaft 100.

The second joint unit 220 comprises an enlarged part 221, which has a shape corresponding to a space formed by the angled inner surfaces 213 of the two locking members 211 when the two locking members 211 are united into a single body, and a connection part 222, which extends from the enlarged part 221 and fixes or connects the composite drive shaft 100 to another element. The upper and lower surfaces of the enlarged part 221 have respective angled shapes corresponding to the angled inner surfaces 213 of the two locking members 211, thus being in surface contact with the angled inner surfaces 213 of the locking members 211, and have inclined surfaces corresponding to the inclined surfaces of the angled inner surfaces 213. In other words, the enlarged part 221 is tapered in a direction from one end to the other end thereof, with the connection part 222 extending from the thick end of the enlarged part 221. Further, the enlarged part 221 has two longitudinal through holes 221a, which are formed in opposite sides of the enlarged part 221 in longitudinal directions. The third joint unit 230 is partially inserted into the through holes 221a and is fastened to the ends of the through holes 221a.

The third joint unit 230 comprises a locking part 231, which is inserted into each end of the composite drive shaft 100 and is fastened in the end of the drive shaft 100 in a state in which the locking part 231 is in frictional surface contact with inclined protrusions 122 of the inner protrusions 120, and an assembling part 232, which extends from one end of the locking part 231 and is inserted into the through holes 221a in the second joint unit 220 prior to being fastened to the ends of the through holes 221a.

The locking part 231 comprises a pair of curved depressions 231a (first depression), which have shapes corresponding to the curved protrusions 121 formed in each end of the composite drive shaft 100 so as to be inserted into the end of the drive shaft 100 along the curved protrusions 121, and a pair of inclined depressions 231b (second depressions), which are formed in the locking part 231 at locations angularly spaced apart from the two curved depressions 231a at angles of 90° and have shapes corresponding to the inclined protrusions 122 of the inner protrusions 120 so as to be fastened in each end of the drive shaft 100 in a state in which the inclined depressions 231b are in frictional surface contact with the inclined protrusions 122 of the inner protrusions 120. Thus, the two curved depressions 231a and the two inclined depressions 231b are angularly spaced apart from each other at angles of 90°. On the other hand, each of the inclined depressions 231b has an inclined shape with a tapered width so as to be fastened in a state in which it is in surface contact with an associated inclined protrusion 122. Here, the two curved depressions 212a of the first joint unit 210 hold the connection joint 200 in the composite drive shaft 100 in a radial direction. The two inclined depressions 231b of the third joint unit 230 hold the connection joint 200 in the composite drive shaft 100 in an axial direction.

The assembling part 232 comprises a pair of bolts 232a, which extend from one surface of the locking part 231 to a predetermined length, and a pair of nuts 232b, which are tightened with the respective bolts 232a. The two bolts 232a are located at positions at which the two bolts 232a can be inserted into the two through holes 221a in the second joint unit 220. Each of the two bolts 232a has a length, which is determined such that the bolts 232a can pass through and protrude outwards from the through holes 221a to a predetermined length. The nuts 232b are tightened to the respective bolts 232a protruding from the through holes 221a after passing therethrough, thus fastening the bolts 232a to the outer ends of the through holes 221a.

Hereinbelow, the process of producing a composite drive shaft assembly according to the present invention by assembling the connection joints, having the above-mentioned construction, in opposite ends of the composite drive shaft will be described.

FIG. 10 is a view illustrating the concept of the composite drive shaft assembly according to the present invention, which is formed by assembling the connection joints of FIG. 2 in the opposite ends of the composite drive shaft shown in FIG. 1.

As shown in FIG. 1 through FIG. 10, the third joint unit 230 of the connection joint 200 is primarily inserted into each end of the composite drive shaft 100. In the above state, the two curved depressions 231a of the third joint unit 230 are moved along the two curved protrusions 121 formed on the inner surface of the composite drive shaft 100. Here, the third joint unit 230 is inserted into the composite drive shaft 100 until the two curved depressions 231a reach a position at which the curved depressions 231a are not in contact with the two curved protrusions 121. Thereafter, the third joint unit 230 is rotated in a forward or reverse direction at an angle of 90° such that the two inclined depressions 231b of the third joint unit 230 are aligned with the two inclined protrusions 122 of the composite drive shaft 100 along the same longitudinal lines. In the above state, the third joint unit 230 is pulled outwards from the composite drive shaft 100 such that the two inclined depressions 231b of the third joint unit 230 are brought into frictional surface contact with the two inclined protrusions 122 of the composite drive shaft 100, thus being fastened thereto. Therefore, even when the third joint unit 230 in the above state is pulled outwards from the composite drive shaft 100, the third joint unit 230 is fastened in the composite drive shaft 100 without being removed therefrom.

Thereafter, the two locking members 211, which constitute the first joint unit 210, are assembled with the enlarged part 221 of the second joint unit 220 such that the angled inner surfaces 213 of the locking members 211 are in surface contact with the upper and lower surfaces of the enlarged part 221 of the second joint unit 220. The assembled first and second joint units 210 and 220 are inserted into the drive shaft 100 such that the through holes 221a in the second joint unit 220 are fitted over the two bolts 232a of the third joint unit 230 and, at the same time, the curved depressions 212a in the two locking members 211 face the curved protrusions 121 formed on the inner surface of the composite drive shaft 100. In other words, the assembled first and second joint units 210 and 220 are inserted into the composite drive shaft 100 until the ends of the two locking members 211 come into contact with a surface of the locking part 231 of the third joint unit 230.

Thereafter, two nuts 232b are tightened to the bolts 232a, which protrude outwards from the through holes 221a. In the above state, the third joint unit 230 is fastened to the composite drive shaft 100. Thus, as the nuts 232b are tightened to the bolts 232a, the enlarged part 221 of the second joint unit 220 is moved inwards in the composite drive shaft 100 in a state in which the upper and lower surfaces of the enlarged part 221 are in surface contact with the inner surfaces 213 of the two locking members 211. Here, the enlarged part 221, which is inserted into the inner surfaces 213 of the locking member 211, is tapered such that the leading end thereof is thinner than the trailing end thereof, thus having inclined surfaces, and the inner surfaces 213 of the locking members 211 have inclined surfaces corresponding to the inclined surfaces of the enlarged part 221. Thus, when the nuts 232b are tightened, the two locking members 211 are gradually opened such that the outer surfaces 212 thereof come into close contact with the inner surface of the composite drive shaft 100. In other words, the curved depressions 212a of the outer surfaces 212 are in close contact with the curved protrusions 121 of the composite drive shaft 100, and the curved surfaces, defined on opposite sides of the curved depressions 212a, are in close contact with the inner curved surface of the composite drive shaft 100, thus being fastened thereto.

The composite material may be easily damaged even by a small shock. If the connection joint 200 and the composite drive shaft 100 are produced such that the junction surfaces thereof have precise dimensions, no problem will occur in the assembled connection joints and composite drive shaft. However, if a thermal expansion coefficient due to temperature differences according to seasonal variation is considered, it may be difficult to maintain the precise dimensions of the connection joints and the composite drive shaft having different physical properties. Thus, the junctions between the connection joints and the composite drive shaft may be bonded using a bonding agent. The bonding using the bonding agent is not intended to give a high strength to the junctions for power transmission, but is intended to remove small spaces, which may be formed in the junctions between the connection joints and the composite drive shaft, thus preventing shocks from being directly applied to the composite drive shaft when the drive shaft transmits power.

Therefore, in the embodiment, when the above-mentioned process is executed in a state in which a bonding agent is applied to the outer surfaces of the two locking members 211 and/or to the inner surface of each end of the composite drive shaft 100, the connection joint 200 can be efficiently fastened to the end of the composite drive shaft 100.

Thus, when two connection joints 200 are fastened to opposite ends of a composite drive shaft 100 in the above-mentioned manner, a composite drive shaft assembly 300 according to the present invention can be produced.

Although the embodiments of a connection joint and a composite drive shaft assembly having the connection joint have been disclosed for illustrative purposes with reference to the accompanying drawings, the embodiments are not intended to indicate the limits of the present invention.

Those skilled in the art will appreciate that various modifications, additions and sub-situations are possible, without departing from the scope and spirit of the invention as disclosed in the accompanying claims.

### INDUSTRIAL APPLICABILITY

As described above, the present invention produces a drive shaft, which is used for transmitting the rotating force of an engine or a gear box to driving axles using a composite material, and assembles respective connection joints in opposite ends of the composite drive shaft, thus allowing the composite drive shaft to be widely used in machinery, including transport machines, such as automobiles, ships and aircraft.

1. A connection joint, which is fastened to a pair of protrusions in each end of a composite drive shaft, thus forming a composite drive shaft assembly, the pair of protrusions of the composite drive shaft being configured such that, regardless of a position at which the drive shaft having the protrusions on an inner surface thereof is cut in a transverse direction, a transverse directional length thereof can be maintained constant, and each comprising a first protrusion longitudinally formed from each end of the drive shaft to a position spaced apart from the end by a predetermined distance, and a second protrusion inclinedly extending from the first protrusion to the inner surface of the drive shaft, the connection joint comprising:
a first joint unit, comprising a pair of locking members, the locking members having a symmetrical structure and each comprising: an outer surface configured such that, when the locking members are inserted into each end of the composite drive shaft in an assembled state, the outer surface is in close contact with the inner surface of the composite drive shaft having the pair of first protrusions; and an inner surface having an inclined surface, which is inclined downwards from a first end to a second end thereof;
a second joint unit, comprising: an enlarged part being tapered in a direction from a first end to a second end thereof such that upper and lower surfaces thereof have respective inclined surfaces corresponding to the inner surfaces of the pair of locking members, thus being in surface contact with the inner surfaces of the locking members, with a pair of through holes formed in opposite sides of the enlarged part in longitudinal directions; and a connection part extending from the first end of the enlarged part; and
a third joint unit comprising: a locking part configured to be inserted into each end of the composite drive shaft along the pair of first protrusions and to be fastened to the pair of second protrusions; and an assembling part extending from a surface of the locking part so as to be inserted into the through holes in the second joint unit prior to being fastened to an end of the second joint unit, thus fastening the pair of locking members of the first joint unit to the inner surface of the composite drive shaft.

2. The connection joint according to claim 1, wherein the locking part of the third joint unit comprises:
a pair of first depressions having a shape corresponding to the pair of first protrusions formed in each end of the composite drive shaft, so that the first depressions can be inserted into each end of the drive shaft along the first protrusions; and
a pair of second depressions formed at locations angularly spaced apart from the pair of first depressions at angles of 90° and having a shape corresponding to part of the pair of second protrusions, thus being fastened to the second protrusions.

3. A composite drive shaft assembly comprising: the connection joint of claim 1, which is fastened in each end of the composite drive shaft of claim 1.

4. The composite drive shaft assembly according to claim 3, wherein a bonding using a bonding agent is added to a junction between the first joint unit and the composite drive shaft.
